(19) United States
(12) Patent Application Publication
(10) Pub. No.: US 2014/0178599 A1
(43) Pub. Date: Jun. 26, 2014

(54) METHODS OF MAKING DETACKIFIED ADHESIVE ARTICLES

(71) Applicants: Robin E. Wright, Inver Grove Heights, MN (US); Nedlin B. Johnson, Minneapolis, MN (US); Margaux B. Mitera, New Richmond, WI (US); Jayshree Seth, Woodbury, MN (US)

(72) Inventors: Robin E. Wright, Inver Grove Heights, MN (US); Nedlin B. Johnson, Minneapolis, MN (US); Margaux B. Mitera, New Richmond, WI (US); Jayshree Seth, Woodbury, MN (US)

(73) Assignee: 3M INNOVATIVE PROPERTIES COMPANY, St. Paul, MN (US)

(21) Appl. No.: 14/236,352

(22) PCT Filed: Sep. 4, 2012
(86) PCT No.: PCT/US2012/053602

§ 371 Date: Jan. 31, 2014

Related U.S. Application Data
(60) Provisional application No. 61/534,508, filed on Sep. 14, 2011.

(51) Int. Cl. C09J 7/02

(52) U.S. Cl. CPC C09J 7/02
USPC 427/535; 427/558; 427/554

(57) ABSTRACT

Methods of reducing tack of edge faces of a roll of an adhesive coated substrate. The method includes reducing tack of the edge faces by subjecting the edge faces to a radiation source with radiant output at a wavelength of less than 200 nanometers.

### FIELD

The present disclosure relates to the detackification of substrates bearing an adhesive and, particularly, to the use of radiation to reduce tack of adhesive-coated substrates.

### SUMMARY

In a first aspect, a method of reducing or eliminating edge tack of an adhesive on a substrate is provided. The method includes providing a rolled substrate. The rolled substrate includes a first edge face and a second edge face opposite said first edge face. The substrate includes an upper major surface and a lower major surface. An adhesive coating is disposed on either or both of the upper major surface and the lower major surface. The method further includes reducing edge tack of either or both of the first and second edge face by subjecting either or both of the first and second edge faces to a radiation source with radiant output at a wavelength of less than 200 nanometers.

In another aspect, a rolled article is provided. The rolled article includes a substrate including an upper major surface and a lower major surface. An adhesive coating is disposed on either or both of the upper major surface and the lower major surface. The rolled article further includes a first edge face having reduced tack, and a second edge face opposite the first edge face. The first edge face is substantially free of coatings other than said adhesive coating.

The above summary of the present disclosure is not intended to describe each embodiment of the present invention. The details of one or more embodiments of the disclosure are also set forth in the description below. Other features, objects, and advantages of the invention will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIG. 1 illustrates a perspective view of a roll of an adhesive coated substrate, which may be subjected to irradiation in accordance with some embodiments of the present disclosure.

### DETAILED DESCRIPTION

Rolls of adhesive coated substrates (e.g., adhesive tape) are commonly prepared by applying (e.g., by coating) an adhesive composition to a substrate (e.g., backing, release liner) and then winding the substrate on a cylindrical core to form the rolls. Commonly, multiple rolls of adhesive coated substrates are packaged in a stack, one on top of another.

Often times, rolls of adhesive coated substrates include exposed adhesive on their edge faces, which renders the edge faces tacky. Such exposed adhesive may result from outward flow of the adhesive during processing (e.g., slitting, winding) or storing of the rolled substrates. Edge face tackiness may be undesirable for several reasons. For example, during use of a roll, dust, dirt, and other particulate matter that contacts the roll edge faces can collect on the edge faces. This phenomenon is particularly undesirable in instances in which the physical appearance and/or cleanliness of the tape is important to users (e.g., medical tape). As an additional example, in instances in which rolls of adhesive coated substrates are packaged on top of one another, edge face to edge face, the exposed adhesive tends to cause adjacent rolls to undesirably adhere to one another, or block.

Methods have been developed to detackify the edge faces of rolls of adhesive coated substrates and/or mitigate blocking of packaged rolls of adhesive coated substrates. One method directed at mitigating blocking of packaged rolls involves placing a release or release coated material (e.g., paper, silicone wafer) between adjacent rolls in a stack. An additional method involves the application of glass beads to the roll edge faces to mask the exposed adhesive. Other methods include application of a non-tacky coating over the edge faces which can be radiation cured (International Publication WO 02/074875) or solution cast (International Publication WO 02/074876).

WO 2008/095653 involves methods of passivating the edges of pressure sensitive adhesive tapes. Among the passivation methods discussed is ultraviolet radiation at wavelengths ranging from 200 to 400 nanometers. WO 2008/095653 provides that photoinitiators and multifunctional monomers are contained in the pressure sensitive adhesive compositions to accelerate the crosslinking or breakdown of the pressure sensitive adhesive structures.

A non-analogous reference involving the manufacture of semiconductor microchips, International Publication WO 03/050196, discusses detackification of the entirety of a major surface of an adhesive coated transparent film substrate using a medium pressure mercury arc lamp. WO 03/050196 provides that a thermally stable free radical initiator is added to the adhesive composition to achieve a desired detackification process.

U.S. Pat. No. 6,890,405 discusses the reduction of tackiness in recycled paper by the addition of talc and a terpene to paper stock in conjunction with chemical fixing agents and retention aids.

Definitions

As used herein, including the claims, the terms “detackification” or “detackifying” refer to a lowering of adhesion of an adhesive composition (i.e., reduction or elimination of tackiness).

As used herein, including the claims, the terms “radiation detackification” or “radiation detackified” refer to a lowering of adhesion occurring by exposure of an adhesive composition to selected radiation. The downward change during exposure produces an adhesive with lower tack.

As used herein, including the claims, the term “penetration depth” refers to the distance into a coating at which the Beer-Lambert absorption of incident radiation responsible for detackification exceeds about 95%. For purposes of the present disclosure, an adhesive composition is radiation detackified to a depth equivalent to about 33% of the penetration depth.

As used herein, including the claims, the term “(co)polymer” means a homopolymer or a copolymer.

As used herein, including the claims, the term “(meth)acrylic” with respect to a monomer means a vinyl-functional alkyl ester formed as the reaction product of an alcohol with an acrylic or a methacrylic acid, for example, acrylic acid or methacrylic acid. With respect to a (co)polymer, the term means a (co)polymer formed by polymerizing one or more (meth)acrylic monomers.

As used herein, including the claims, the term “non-contact treatment” refers to any treatment that does not involve the application or contact of physical matter (e.g., coatings, particulates, tooling) to a subject surface.

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

In accordance with exemplary embodiments of the present disclosure, one or more edge faces of a roll of an adhesive coated substrate are subjected to irradiation to produce detackified edge faces. Prior to radiation exposure, the edge faces are not subjected to a pre-treatment that achieves and/or facilitates detackification (e.g., application of powders, particulates, solutions, gels, pastes or any other contact/chemical coating treatment). The detackification methods of the present disclosure do not require the use of a photoinitiator. The detackification methods of the present disclosure, while adequately reducing the tackiness of edge faces, do not adversely affect the adhesive properties of the adhesive coating disposed on a major surface of the substrate, particularly, the ability of an adhesive coated edge of a major surface of the unrolled substrate to adhere to a surface. Furthermore, the detackification methods of the present disclosure reduce the edge face tackiness to a level sufficient to substantially prevent collection of debris on the edge faces as well as blocking of rolled substrates that are packaged edge face to edge face.

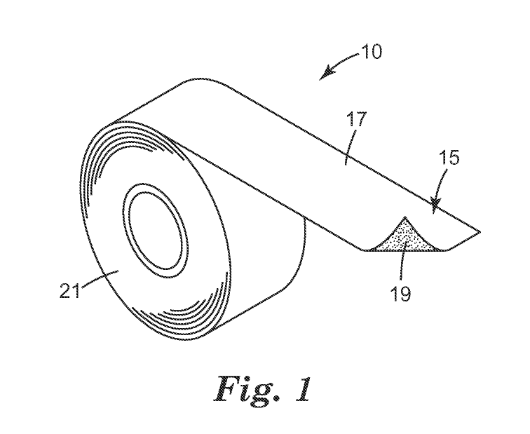

FIG. 1 illustrates a perspective view of a roll 10 of an adhesive coated substrate 15, which may be subjected to irradiation in accordance with some embodiments of the present disclosure. The substrate 15 may be formed as a continuous web of material. Alternatively, the substrate 15 may be formed as two or more web segments separated by, for example, cuts, score lines, perforations, or the like. In either scenario, the substrate 15 may include a first, or upper major surface 17 and a second, or lower major surface 19 opposite the upper major surface 17. Either or both of the upper major surface 17 and the lower major surface 19 may have an adhesive composition disposed thereon. The adhesive composition (or an adhesive precursor composition) can be solvent borne, waterborne, or solvent-free and may be applied to a major surface of the substrate 15 via any coating method including, without limitation, roll coating, knife coating, hot melt coating, spray coating, vapor coating, or curtain coating. The coated adhesive or adhesive precursor composition can be converted to an adhesive coating on the substrate 15 using methods known to those skilled in the art. After the adhesive coated substrate is rolled, the roll 10 may include a first edge face 21 and a second edge face (not shown). Each of the first edge face 21 and the second edge face may have one or more portions, up to the entirety of the edge face, on which the adhesive composition is exposed to form an undesirable edge face layer of adhesive.

The adhesive coating disposed on a major surface of the substrate 15 may include a pressure sensitive adhesive. Pressure sensitive adhesives useful in the methods of the present disclosure may include, without limitation, natural rubber, styrene butadiene rubber, styrene-isoprene-styrene (co)polymers, styrene-butadiene-styrene (co)polymers, polyacrylates including (meth)acrylic (co)polymers, polyolefins such as polyisobutylene and polyisoprene, polyurethane, polyvinyl ethyl ether, polysiloxanes, silicones, polyurethanes, polyureas, and blends thereof.

In various embodiments, the pressure sensitive adhesives useful in the methods of the present disclosure may be UV-polymerized pressure sensitive adhesives. For purposes of the present disclosure, including the claims, the term “UV-polymerized pressure sensitive adhesives” may refer to pressure sensitive adhesives formed by polymerization of a pressure sensitive adhesive precursor composition (e.g., one or more mono-, di-, or polyfunctional monomers) that includes a photoinitiator, by exposure of the precursor composition to UV radiation. Examples of photoinitiators that may be utilized include free radical photoinitiators such as benzoin and its derivatives, benzil ketals, acetophenone and its derivatives, benzophenone and its derivatives, and phosphine oxides as well as cationic photoinitiators such as onium salts including diaryl iodonium and triarylsulfonium salts.

In other embodiments, the pressure sensitive adhesives useful in the methods of the present disclosure may be non-UV-polymerized pressure sensitive adhesives. Polymerization methods for such non-UV-polymerized pressure sensitive adhesives include, without limitation, thermal, e-beam, and gamma-ray treatment. It is to be appreciated that non-UV polymerization methods do not require the use of a photoinitiator. Therefore, non-UV-polymerized pressure sensitive adhesives (as well as the pressure sensitive adhesive precursor compositions) useful in the methods of the present disclosure may not include any amount of a photoinitiator.

In illustrative embodiments, the adhesive coatings useful in the methods of the present disclosure may include one or more additives. Additives may include, without limitation, tackifiers, plasticizers, pigments, dyes, and/or fillers.

In various embodiments, the rolls of adhesive coated substrates of the present disclosure may be rolls of an adhesive tape that includes a backing layer and an adhesive coating disposed on a major surface of the backing layer. The adhesive tape rolls may further include a release coating, or low adhesion backsize, disposed on a second major surface. Alternatively, the adhesive tape rolls may include a release liner (which may have a release coating disposed on a major surface thereof) in contact with the adhesive coated major surface of the backing layer. As another example, an adhesive tape roll may include a release liner comprising a release coating disposed on at least a portion of each of its major surfaces and an adhesive coating deposited over one of the release coatings.

Examples of suitable backing layers include, without limitation, cellophane, acetate, fiber, polyester, vinyl, polyethylene, polypropylene including, e.g., monoaxially oriented polypropylene and biaxially oriented polypropylene, polytetrafluoroethylene, polyvinylfluoroethylene, polyurethane, polyimide, paper (e.g., polycoated Kraft paper, and supercalendered or glassine Kraft paper), woven webs (e.g., cotton, polyester, nylon and glass), nonwoven webs, foil (e.g., aluminum, lead, copper, stainless steel and brass foil tapes) and combinations thereof. Examples of suitable release liner substrates include papers and polymeric films. Examples of suitable release coating compositions include, without limitation, silicone, fluorocarbons, and polyolefins including, e.g., polyethylene and polypropylene. The backing layers and, when present, release liners, can also include reinforcing agents including, without limitation, fibers, filaments (e.g., glass fiber filaments), and saturants (e.g., synthetic rubber latex saturated paper backings). Common types of adhesive tapes that can be detackified utilizing the methods of the present disclosure include masking tape, electrical tape, duct tape, filament tape, medical tape, transfer tape, and the like.

Methods of edge face detackification in accordance with embodiments of the present disclosure may include subjecting one or more roll edge faces to irradiation. In one embodiment, the radiation source is non-ionizing. In a further embodiment, the non-ionizing radiation source is an ultraviolet light source. Ultraviolet light sources useful in the methods of the present disclosure may include those having radiant output at wavelengths as high as 240 nm, 300 nm, or even as high as 400 nm, and as low as 170 nm, 160 nm, as low as 150 nm, or even as low as 120 nm. The ultraviolet light sources may include those having radiant output at wavelengths ranging between about 150 nm and 200 nm, or between about 170 nm and about 200 nm. The ultraviolet light sources may include, but are not limited to, deuterium lamps, low-pressure mercury lamps, low-pressure mercury amalgam lamps, pulsed xenon sources, excimer lasers, and excimer lamps. Examples of excimer ultraviolet light sources include lamps such as those commercially available from Osram (Massachusetts, United States), Heraeus-Noblelight (Hanau, Germany), Ushio (Tokyo, Japan), and those described in Kogelschatz, Applied Surface Science, 54 (1992), 410-423, glow discharge lamps such as those described in EP Patent Appl. 521,553 (assigned to N. V. Philips), microwave driven lamps such as those described in Kitamura et al., Applied Surface Science, 79/80 (1994), 507-513 and DE 4302555 A1 (assigned to Fusion Systems), and excimer lamps pumped by a volume discharge with ultraviolet preionization as described in Tech. Phys, 39(10), 1054 (1994).

In further embodiments, the radiation source may be a glow discharge from a plasma source. Such sources may involve excitation of a carrier gas (e.g. nitrogen) to generate electrons, ions, radicals, and photons. As reported in, for example, Elsner, et.al. [Macromol. Mater. Eng. 2009, 294, 422-31], a variety of acrylate monomers can be cured in the absence of photoinitiators using a nitrogen plasma polymerization process in which UV spectral lines, including bands near 150 nm, 175 nm, and 220 nm were observed.

In some embodiments, exposure to the radiation source may be carried out in a controlled environment (e.g., chamber) that is substantially free of oxygen. Substantially oxygen free environments may be particularly useful in embodiments in which the radiation source has radiant output at wavelengths of less than about 200 nm. In such embodiments, oxygen gas present in the environment may absorb the UV radiation, thereby substantially preventing the radiation from reaching the target surface. In one embodiment, the methods of the present disclosure may be carried out in an inert environment including an inert gas such as nitrogen. In embodiments in which an inert gas is used, oxygen levels in the environment may be as low as 50 ppm, 25 ppm, or even as low as 10 ppm, and as high as 100 ppm, 500 ppm, or even as high as 1000 pm. In further embodiments, the controlled environment may be operated at a vacuum pressure. In embodiments in which vacuum pressures are employed, the pressures may as low as 10⁻⁴ torr, 10⁻⁵ torr, or even as low as 10⁻⁶ torr, and be as high as 10⁻³ torr, as high as 10⁻² torr, as high as 10⁻¹ torr, as high as 1 torr, as high as 10 torr, or even as high as 100 torr. In some embodiments, the detackification methods of the present disclosure do not require the use of a photoinitiator. In this regard, the methods of the present disclosure may include subjecting one or more roll edge faces having exposed adhesive to irradiation, and the exposed adhesive (or edge face layer of adhesive) may not include a photoinitiator.

The irradiance or incident radiation levels useful in the methods of the present disclosure can be as low as 10, 1, 0.1, or even as low as 0.010 mW/cm² , and as high as 1, 2, 5, or even as high as 10.0 W/cm². In some embodiments, incident radiation levels useful in the methods of the present disclosure can range from about 0.010 mW/cm² to about 2.0 W/cm², 0.1 mW/cm² to about 1.0 W/cm², or 1.0 mW/cm² to about 100 mW/cm².

In some embodiments, the detackification methods of the present disclosure may include exposing an edge face of a roll of an adhesive coated substrate to irradiation while the roll is stationary. Alternatively, the edge faces may be exposed to irradiation while the rolls are being conveyed by a suitable conveying apparatus. In either scenario, the gap between the edge face to be detackified and the source of radiation, as well as the exposure time of the edge face to incident radiation, may be selected based upon a variety of factors related to, for example, the desired irradiance level, the rolled substrate dimensions and/or the composition of the adhesive coating.

Upon exposure to radiation in accordance with the methods of the present disclosure, the edge faces of rolled adhesive coated substrates may become detackified without adversely affecting the adhesive qualities of the adhesive coating disposed on the major surfaces of the rolled substrate. As discussed above, outward flow of the adhesive coating during processing and/or storage may result in exposure of the adhesive coating on the edge faces of the rolls. Particularly, a layer or coating of the adhesive composition may be present on any portion, including the entirety, of an edge face. Utilizing, in some embodiments, the ultraviolet radiation detackification methods of the present disclosure, this layer of exposed adhesive may be detackified to a penetration depth of less than 10 microns, 5 microns, or even less than 1 micron. In this manner, the irradiation treatments of the present disclosure may not adversely affect (i.e., detackify to any extent) the adhesive coating disposed on a major surface of the substrate 15, including any adhesive coated on the perimeter of the major surface of the substrate 15. Consequently, the detackification methods of the present disclosure may not have a deleterious effect on the ability of an edge of an adhesive coated major surface of the unrolled substrate 15 to adhere to a surface.

Roll edge faces detackified in accordance with embodiments of the present disclosure may not be subjected to a pre-treatment. That is, in contrast to previous methods which involve the application of coatings (e.g., powders, particulates, solutions, gels, pastes, or any other contact/chemical coating treatment) to the edge faces to achieve and/or facilitate detackification, the detackification methods of the present disclosure do not require such additional processing steps.

The edge face detackified rolls of adhesive coated substrates of some embodiments the present disclosure can be stacked upon each other edge face to edge face without blocking such that each detackified roll can be easily removed from a stack. The edge face detackified rolls of some embodiments can also be packaged without significant adhesion to packaging materials such as plastic, cardboard, and metal. Roll edge faces detackified in accordance with exemplary methods of the present disclosure are also less apt to pick up dirt and other contaminates relative to edge faces that have not been detackified.

### EXAMPLES

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### Examples

TABLE 1
Materials Used in the Preparation of the Examples

| I.D. | Description | Source |
|---|---|---|
| Tape 1 | Silicone Tape 2775-1; silicone | 3M Company, St. Paul, |
| | pressure sensitive adhesive, paper | MN, USA |
| | blend backing | |
| Tape 2 | Acrylic Seam Tape | 3M Company, St. Paul, |
| | | MN, USA |
| Tape A | VHB™ 4910; double-sided, | 3M Company, St. Paul, |
| | pressure-sensitive, acrylic tape with | MN, USA |
| | PE film liner, 1.02 mm (40 mil) | |
| | thick | |
| Tape B | High Temperature Aluminum Foil | 3M Company, St. Paul, |
| | Tape 433 Silver; 0.09 mm (3.6 mil) | MN, USA |
| | aluminum foil backing with | |
| | pressure sensitive silicone adhesive | |
| Tape C | Vinyl Tape 471; 0.11 mm (4.2 mil) | 3M Company, St. Paul, |
| | vinyl backing with a rubber | MN, USA |
| | adhesive | |
| Tape D | VHB™ 4955; 2.03 mm (80 mil) | 3M Company, St. Paul, |
| | closed cell acrylic foam tape with | MN, USA |
| | PET film liner | |
| Tape E | Scotch™ 2090 Blue Painter's Tape | 3M Company, St. Paul, |
| | | MN, USA |
| Tape F | Scotch™ Box Sealing Tape 375; | 3M Company, St. Paul, |
| | 0.03 mm (1.1 mil), pressure | MN, USA |
| | sensitive hot melt rubber resin | |
| | adhesive on 0.05 (2.0 mil), biaxially | |
| | oriented polypropylene film | |
| Tape G | Scotch™ Removable Tape 811; | 3M Company, St. Paul, |
| | repositionable acrylic adhesive | MN, USA |
| Tape H | Scotch™ Box Sealing Tape 373; | 3M Company, St. Paul, |
| | 0.064 mm (2.5 mil) polypropylene | MN, USA |
| | tape with rubber resin adhesive | |
| Tape I | Scotch™ Filament Tape 898 Clear; | 3M Company, St. Paul, |
| | 0.168 mm (6.6 mil) clear | MN, USA |
| | polypropylene backing with | |
| | reinforced with glass yarn filaments | |
| | with a synthetic rubber resin | |
| | adhesive | |
| Tape J | Vinyl Plastic Electrical Tape 471; | 3M Company, St. Paul, |
| | 0.13 mm (5.2 mil) vinyl backing | MN, USA |
| | with a rubber adhesive | |
| Tape K | Polyester Silicone Adhesive Tape | 3M Company, St. Paul, |
| | 8403 Green; 0.06 mm (2.3 mil) | MN, USA |
| | polyester film tape with green | |
| | pigmented silicone adhesive | |

Test Methods

Pepper Test Procedure

The subject surfaces were sprinkled with common ground black pepper (fine ground), such that the surfaces were dusted with approximately the same amount of pepper. The pepper was allowed to dwell on the surface for 5 minutes before it was inverted and gently shaken to remove excess, non-adhering pepper. The subject surfaces were then physically inspected to quantify the amount of residual pepper granules, estimated as a percent areal coverage of the residual pepper on the subject surface.

Work of Adhesion

A texture analyzer, model TX-TAplus, available from Stable Microsystems LTD. (Godalming, UK), was fitted with at 5 kg load cell and a 6 mm diameter cylindrical stainless steel probe. The tape samples were secured below the probe and the probe compressed the edge face of the roll with a total force of 200 grams. This compressive force was maintained for 11 seconds, after which the probe was withdrawn from the sample at a rate of 2 mm/sec. The total amount of force involved in the probe withdrawal from the sample is taken as the “Work of Adhesion” (units for work of adhesion are g*s)

### Example 1

### Detackification of an Edge of a Roll of a Silicone Pressure Sensitive Adhesive Tape

A polyethylene terephthalate (PET) carrier web was threaded through the entrance and exit slits of an inertable cure chamber which housed a 610 mm long Xeradex dixenon excimer lamp (Osram, Germany) oriented at 90° relative to the web path. The chamber was purged with nitrogen gas to an oxygen level of less than 50 ppm. A roll of 1. Tape 1, having noticeable edge tackiness (e.g., to the touch), was laid with one tape roll edge lying flat on the PET web and the roll was transported through the chamber at a speed of 0.31 meters per minute (mpm) thereby exposing the other roll edge surface to a 172 nm emission peak. The distance of the lamp from the top tape roll edge was approximately 5 cm. The exposed edge was found to have no tack when touched. The energy, measured with a Hamamatsu (Hamamatsu City, Japan) Model C8026 UV power meter using an H-8025-172 detector head, was 400 mJ/cm². A Pepper Test showed less than 5% coverage compared to well over 25% with no exposure. The results are shown in Table 2.

### Examples 2-3

### Effect of Web Speed on Edge Tack of a Silicone Adhesive Tape Roll Edge

The procedure of Example 1 was repeated using fresh rolls of Tape 1 at speeds of 1.2 and 2.4 mpm. The exposed surfaces showed increased tack relative to the edge tested in Example 1 but still noticeably lower than the tack of the unexposed control. The amount of tack was proportional to line speed with samples exposed at lower line speed showing lower tack. Pepper test results qualitatively followed this same trend. Results are shown in Table 2.

TABLE 2

| Example | | Speed, | Finger | Work of Adhesion, g * s |
|---|---|---|---|---|
| No. | Description | mpm | Tack | (standard deviation) |
| C1 | Tape 1 | NA | Tacky | 2.26 (1.23) |
| 1 | Tape 1 | 0.31 | Not tacky | 0.159 (0.185) |
| 2 | Tape 1 | 1.2 | Not tacky | 0039 (0.037) |
| 3 | Tape 1 | 2.4 | Not tacky | 0.504 (0.382) |

### Examples 4-9

Rolls of Tape 2 were exposed to the 172 nm emission following the procedure of Example 1. The lamp was at a distance of 1 cm from the tape roll edge to be detackified. Results are summarized in Table 3.

TABLE 3

| Example | | |
|---|---|---|
| No. | Speed, mpm | Tack |
| 4 | 0.15 | None |
| 5 | 0.31 | Low |
| 6 | 0.61 | Low |
| 7 | 0.91 | Low to Medium |
| 8 | 2.4 | Medium |
| 9 | 4.9 | High |

### Examples 10-42

An indirect exposure method for evaluating the tack level of adhesives exposed to 172 nm radiation was developed which allowed for faster sample screening. The method involved direct exposure of the adhesive surface of 8-10 cm strips of various adhesive tapes and evaluating the degree of tack loss. As an example, a strip of Tape 1 was placed adhesive side up on a PET film and passed through the exposure chamber. The tack was tested using a cotton-tipped applicator and a qualitatively rating (0-5) of the amount of cotton retained by the adhesive after contact with the applicator. Where no cotton was retained, the adhesive was considered detacked. The results are shown in Table 4. Comparatives were not irradiated. The results indicate that the level of tack is inversely related to exposure time. Thus, the present invention provides a means to not only detackify the edges of a roll of adhesive tape but also controllably modify the level of tack of the adhesive coating itself.

TABLE 4

| | | | Tack |
|---|---|---|---|
| Example | | | 0 = tack-free |
| No. | Tape | Speed, mpm | 5 = tacky |
| C2 | A | NA | 5 |
| 10 | A | 0.15 | 0 |
| 11 | A | 0.31 | 1 |
| 12 | A | 1.5 | 3 |
| C3 | B | NA | 4 |
| 13 | B | 0.15 | 0 |
| 14 | B | 0.31 | 1 |
| 15 | B | 1.5 | 2 |
| C4 | C | NA | 5 |
| 16 | C | 0.15 | 0 |
| 17 | C | 0.31 | 1 |
| 18 | C | 1.5 | 4 |
| C5 | D | NA | 5 |
| 19 | D | 0.15 | 0 |
| 20 | D | 0.31 | 1 |
| 21 | D | 1.5 | 2 |
| C6 | E | NA | 5 |
| 22 | E | 0.15 | 0 |
| 23 | E | 0.31 | 2 |
| 24 | E | 1.5 | 3 |
| C7 | F | NA | 5 |
| 25 | F | 0.15 | 0 |
| 26 | F | 0.31 | 1 |
| 27 | F | 1.5 | 2 |
| C8 | G | NA | 4 |
| 28 | G | 0.15 | 0 |
| 29 | G | 0.31 | 1 |
| 30 | G | 1.5 | 2 |
| C9 | H | NA | 4 |
| 31 | H | 0.15 | 0 |
| 32 | H | 0.31 | 1 |
| 33 | H | 1.5 | 2 |
| C10 | I | NA | 5 |
| 34 | I | 0.15 | 0 |
| 35 | I | 0.31 | 1 |
| 36 | I | 1.5 | 2 |
| C11 | J | NA | 4 |
| 37 | J | 0.15 | 0 |
| 38 | J | 0.31 | 1 |
| 39 | J | 1.5 | 2 |
| C12 | K | NA | 4 |
| 40 | K | 0.15 | 0 |
| 41 | K | 0.31 | 1 |
| 42 | K | 1.5 | 3 |

### Examples 43-50

The procedure of Examples 10-42 was repeated, except the radiation source used was a bank of twelve low-pressure mercury amalgam bulbs (Heraeus-Noblelight, Hanau, Germany) with output at 254 nm and 185 nm. The energy of a 10-second exposure at 185 nm was 175 mJ/cm² (Hamamatsu detector H8025-185). While less effective at reducing the level of tack than the 172 nm source, finger touch results of the adhesive surface tack after exposure to the 185 nm output with the low-pressure mercury amalgam bulb shown in Table 5 were qualitatively the same.

TABLE 5

| | | | Tack |
|---|---|---|---|
| Example | | | 0 = tack-free |
| No. | Tape | Time, sec | 5 = tacky |
| C13 | E | NA | 5 |
| 43 | E | 15 | 5 |
| 44 | E | 45 | 3 |
| 45 | E | 75 | 1 |
| C14 | G | NA | 4 |
| 46 | G | 15 | 4 |
| 47 | G | 45 | 3 |
| 48 | G | 75 | 1 |
| C15 | K | NA | 5 |
| 49 | K | 30 | 3 |
| 50 | K | 60 | 0 |

### Comparative Example C16

### Exposure of Tape D to 254 nm

A strip of Tape D was exposed to the 254 nm output from a bank of twelve germicidal lamps for 5 minutes. There was no noticeable drop in tack confirming that the 185 nm band from the low-pressure amalgam lamp is responsible for the affect noted in Examples 46-48 above.

### Example 51

### Use of a Pulsed Xenon Source to Detackify Tape E

A Model 830 pulsed xenon lamp (Xenon Corp., Wilmington, Mass.) with two synchronized Type ‘D’ bulbs was positioned on a nitrogen-inerted lab conveyor exposure unit. No quartz window was used so that the entire spectral output from the pulsed lamps would irradiate the sample. A strip of Tape E was laid adhesive side up on a metal tray positioned at 2.5 cm below the UV source. The adhesive was exposed for 12 pulses. Each pulse provided an energy of 207 joules. There was no obvious affect on the degree of tack. A fresh strip was then exposed for a total of 40 pulses. When examined, the adhesive was warm and gooey. However, upon cooling, the originally tacky surface was tack-free.

### Example 52

### Use of a Pulsed Xenon Source to Detackify Tape D

The procedure of Example 51 was repeated using a strip of Tape D. After 40 pulses, a reduction in tack was observed.

### Example 53

### Detackifying the Edge of an Adhesive Tape Roll Using a Nitrogen Plasma

Plasma treatments were carried out in a batch plasma system (PlasmaTherm Model 3032, St. Petersburg, Fla.) configured for reactive ion etching (RIE) with a 66 cm lower powered electrode and central gas pumping. The chamber was evacuated using a roots blower (Edwards Model EH1200, Tewksbury, Mass.) backed by a dry mechanical pump (Edwards Model iQDP80). RF power was delivered by a 3 kW, 13.56 MHz solid-state generator (Advanced Energy, Model RFPP-RF30H, Fort Collins, Colo.) through an impedance matching network (Advanced Energy, Model AM-3000, Fort Collins, Colo.).

A roll of Tape 2 was laid flat on the lower electrode of the plasma chamber with one edge facing up. The vessel was closed and the chamber pumped down to a base pressure of less than 10 mTorr before nitrogen gas was introduced through a needle valve to achieve a pressure of 25 mTorr. The tape roll was exposed to 2000 W of nitrogen plasma and concurrent UV emission for 1 minute. After the exposure was completed, the gas was shut off, the chamber vented to atmosphere, and the roll removed. There was a dramatic reduction in tack of the roll edge facing upwards and exposed to the plasma and UV emission. The tape roll was near ambient temperature when removed from the vessel.

### Example 54

### Use of Nitrogen Plasma To Detackify Multiple Edges Of Adhesive Tape Rolls Simultaneously

The process of Example 53 was repeated except four rolls of Tape 1 were positioned on the lower powered electrode of the plasma chamber with a major surface down such that both edges of each tape roll were exposed. The vessel was closed and the chamber pumped down to a base pressure of less than 10 mTorr before introducing the nitrogen gas. The eight adhesive edges were exposed to 2000 W of nitrogen plasma and concurrent UV emission for 1 minute. After the exposure was completed, the gas was shut off, the chamber vented to atmosphere, and the roll removed. There was a dramatic reduction in tack of the eight adhesive edges exposed to the plasma and UV emission. The tape rolls were near ambient temperature when removed from the vessel after completion of the plasma treatment.

Other embodiments of the invention are within the scope of the appended claims.

1. A method of reducing tackiness of an edge face of a rolled substrate, said method comprising:
providing a rolled substrate comprising:
a first edge face; and
a second edge face opposite said first edge face;
wherein the substrate comprises a first major surface and a second major surface, and
wherein an adhesive coating is disposed on either or both of the first major surface and the second major surface; and
reducing the tackiness of either or both of the first and second edge face by subjecting either or both of the first and second edge faces to a non-contact treatment comprising an ultraviolet radiation source with radiant output at a wavelength of less than 200 nanometers.

2. The method according to claim 1, wherein the radiation source comprises an ultraviolet light source with radiant output at a wavelength as low as 120 nm.

3. The method according to claim 2, wherein the ultraviolet light source comprises an excimer lamp, excimer laser, low-pressure mercury lamp, low-pressure mercury amalgam lamp, pulsed xenon lamp, or combinations thereof.

4. The method according to claim 1, wherein the radiation source further comprises a glow discharge from a plasma.

5. The method according to claim 1, wherein an edge face layer of the adhesive coating is disposed on at least a portion of the first edge face and, following irradiation, the edge face layer is detackified to a depth of about 10 microns or less.

6. The method according to claim 1, wherein the adhesive coating comprises a pressure sensitive adhesive.

7. The method according to claim 6, wherein the pressure sensitive adhesive comprises a silicone polymer.

8. The method according to claim 6, wherein the pressure sensitive adhesive comprises a (meth)acrylic (co)polymer.

9. The method according to claim 1, wherein the substrate comprises a polymer, and wherein a release coating is disposed on at least one of the first major surface and the second major surface.

10. The method according to claim 1, wherein the adhesive coating does not comprise a photoinitiator.

11. The method according to claim 1, wherein the step of subjecting either or both of the first and second edge faces to the radiation source is carried out in an environment comprising an oxygen concentration of less than 500 ppm.

12. The method according to claim 1, wherein following tackiness reduction, the subjected edge faces exhibit a Pepper Test areal coverage of about 5% or less.

13. The method according to claim 1, wherein following tackiness reduction, the subjected edge faces exhibit a Pepper Test areal coverage of at least 50% less than a Pepper Test areal coverage of unsubjected edge faces.

14. A method of reducing tackiness of an edge face of a rolled substrate, said method comprising:
providing a rolled substrate comprising:
a first edge face; and
a second edge face opposite said first edge face;
wherein the substrate comprises a first major surface and a second major surface opposite the first major surface, and
wherein a UV-polymerized pressure sensitive adhesive is disposed on either or both of the first major surface and the second major surface; and
reducing the tackiness of either or both of the first and second edge face by subjecting either or both of the first and second edge faces to a non-contact treatment, wherein the non-contact treatment comprises exposure to an ultraviolet radiation source with radiant output at a wavelength of less than 200 nanometers.

15. The method according to claim 14, wherein the subjected edge faces are substantially free of coatings other than said adhesive coating during the non-contact treatment.

16. (canceled)

17. The method according to claim 14, wherein an edge face layer of the adhesive coating is disposed on at least a portion of the first edge face and, following irradiation, the edge face layer is detackified to a depth of about 10 microns or less.

18. The method according to claim 14, wherein the step of subjecting either or both of the first and second edge faces to the radiation source is carried out in an environment comprising an oxygen concentration of less than 500 Ppm.

19. The method according to claim 14, wherein following the non-contact treatment, the subjected edge faces exhibit a Pepper Test areal coverage of about 5% or less.

20. The method according to claim 14, wherein following the non-contact treatment, the subjected edge faces exhibit a Pepper Test areal coverage of at least 50% less than a Pepper Test areal coverage of unsubjected edge faces.

21. A method of reducing tackiness of a substrate bearing an adhesive, said method comprising:
providing a substrate comprising a first major surface and a second major surface, wherein an adhesive coating is disposed on either or both of the first major surface and the second major surface; and
reducing the tackiness of either or both of the first and second major surfaces by subjecting either or both of the upper and lower major surfaces to an ultraviolet radiation source with radiant output at a wavelength of less than 200 nanometers.
